(19) United States
(12) Patent Application Publication
(10) Pub. No.: US 2026/0349116 A1
(43) Pub. Date: Nov. 5, 2026

(54) INTERFERENCE-FREE SPATIAL POSITION DATA TRANSMISSION SYSTEM

(71) Applicant: LLC INSPECTOR SERVICE, Kyiv (UA)

(72) Inventor: Petro METALNIKOV, Kyiv (UA)

(21) Appl. No.: 19/297,416

(22) Filed: Aug. 12, 2025

(30) Foreign Application Priority Data
May 5, 2025 (UA) A 2025 02124

(51) Int. Cl. G01S 19/37

(52) U.S. Cl. CPC G01S 19/37

(57) ABSTRACT

The claimed invention belongs to a field of digital satellite communication and relates to a spatial position data transmission system comprising a satellite communication terminal comprising a central processor, an antenna, an oscillator and a GNSS receiver. According to the invention, the system comprises a parameter optimization device comprising an additional high-accuracy oscillator, a microcontroller and a spatial location data source being external relative to the terminal. The microcontroller is configured to turn on/off the oscillator and the GNSS receiver of the communication terminal and to connect an additional high-accuracy oscillator and the spatial location data source being external relative to the terminal to the central processor of the terminal. The claimed system reduces a risk of influence of signal suppression or distortion tools thereto, is interference-free and allows to maintain the accurate schedule and stably high communication level both during operation in stationary conditions and during movement, while ensuring coordination between time and geolocation being sufficient for current usage scenarios.

### CROSS-REFERENCE TO RELATED APPLICATION

This application claims priority to Ukrainian Application No. a 2025 02124, filed May 5, 2025, which is hereby incorporated by reference in its entirety.

### FIELD OF THE INVENTION

The claimed invention relates to the field of digital satellite communication, in particular, to systems for optimizing communication parameters of satellite communication terminals in order to ensure their reliable operation both in a stationary position and during use on movable objects.

### BACKGROUND

Current digital systems for satellite communication that utilize the TDMA (Time division multiple access) are designed for continuous operation, if reliable data about coordinated time and rather accurate coordinates of physical location of the terminals are available. Main source of this data is represented by Global Navigation Satellite Systems (GNSS), namely, their receivers that are integrated into the communication terminals.

An underlying feature of the TDMA technology is that a communication channel is divided between users according to a time criterion. That is, the same frequencies for data receipt and transmission are used by several users alternately according to a certain usage schedule.

In order to ensure stable operation of this communication channel, all the users must be synchronized with each other in time as accurately as possible and they must carefully follow the usage schedule. Otherwise, the communication terminal will transmit the data beyond the time period assigned therefor simultaneously with another terminal. Therefore, it will not be able to transmit its own data, since a receiving part waits for data from another subscriber within this time period, as well as it will interfere with another terminal, since the receiving part receives two data flows at the same time at the same frequency and cannot differentiate the signal from the noise. The same applies for the opposite direction, i.e., the terminal will receive data from the communication channel within strictly determined time periods. The data being transmitted at the same frequencies within the rest of the time is not addressed to this particular terminal and carries no useful load for the user of this terminal.

Currently, a common worldwide practice to solve this problem is to use signal receivers from GNSS satellites. These satellites have atomic onboard clocks having very high accuracy and minimum deviation over very long time. Data from these clocks is transmitted by them substantially in a form of accurate time signals at the beginning of each second. Then, the GNSS receiver informs a central processor of the communication terminal about occurrence of a new astronomic second by transmitting an impulse via a physical line 1 PPS (1 pulse per second). Also, the GNSS satellites report data about their current location in Earth orbit. Knowing the radio propagation velocity (300,000 km/sec) and having determined the current location of the receiver by means of triangulation, it becomes possible to synchronize the internal clock of the data transmission terminal from the atomic clock with accuracy sufficient for following the schedule. Currently, most of the TDMA communication systems on the planet operate in this way.

Since in most cases, the user terminal does not have any problems to continuously receive accurate time signals from the GNSS satellites, its internal clock may be corrected at a frequency of up to 1 time per second. This possibility allows manufacturers to use low-accuracy oscillators in the embedded clocks, the oscillators have a rather high deviation over a time period. If there is no reliable data from the external synchronization source (GNSS NO FIX), the embedded logics of the terminal will stop correction according to the external source and will rely on the embedded accuracy oscillator that is not sufficient for providing the required reading quality of the time periods. As a consequence, in order to ensure reliable operation of the terminal in the TDMA system, it is required to conduct correction of its internal clock regularly from the external synchronization source, and currently, almost always, it is the atomic clock on board the GNSS satellite. If there is no such possibility, the embedded oscillator of the terminal will soon stop to provide accurate time counts resulting in disturbance of the schedule and quick degradation of the communication quality down to 0, lasting up to 10 minutes.

Another important criterion is a geolocation. All satellite communication terminals are equipped with positioning systems for adjusting a radio signal direction. Regardless of the specific mechanisms of their implementation, the logic of positioning the satellite terminal must know the current position of the satellite it needs to maintain a connection with, relative to itself. Data about orbits of the satellites and their position along these orbits is a part of the schedules of the satellites that is continuously distributed by each of the groups of satellites at standard fixed frequencies. Upon receipt of the schedule and knowing the accurate current time, the logic of the terminal is able to find and to calculate the position of the satellites relative to the Earth's surface. Upon receipt of the data about the current location of the terminal, the positioning logic will calculate a three-dimensional vector of the direction towards the satellite and direct an antenna thereto, while continuously correcting it with consideration of movement of both the satellite and the terminal. Currently, a main source of the data about both the time and its own geolocation is GNSS receivers embedded into the satellite terminals. In most of cases, it operates in this particular way.

Competition between manufacturers of secured interference-free GNSS receivers and manufacturers of devices for suppressing and distorting GNSS last long and hardly will be over in recent years, but since the mass market does not have any problems with suppression or distortion of the GNSS data, nominally, most of the satellite terminals utilize inexpensive and almost insecure receivers.

Therefore, in order to ensure reliable communication between the client terminal and the satellite TDMA-based network that consists of a large number of satellites arranged on the low-earth orbit (LEO), the subscriber terminal must always have high-accuracy data about coordinated time and data of sufficient accuracy about geographic location of the terminal. When the integrated GNSS receiver of the terminal is not able to receive data about time and position of the terminal or when the received data is distorted, the communication quality will be deteriorated significantly or the communication will be fully lost. Since these problems are not common to most regions, manufacturers of equipment and operators of satellite networks do not pay much attention to resolving this problem.

Currently, in the regions where there is no signal from the Global Navigation Satellite Systems (GNSS/GPS Denied Environments) or if it is suppressed or distorted, the integrated GNSS receiver of the terminal is not able to receive data about time and position, thereby rendering it impossible to use the terminal.

Currently, a known solution provides a data transmission system comprising a satellite communication terminal that, in turn, comprises a central processor, an antenna, a transceiver, an oscillator and a GNSS receiver, wherein an alternative external antenna is used for protection against interference signals, and the external antenna is used when the embedded antenna loses a useful signal. This improvement may be used both for stationary terminals and for terminals mounted on movable objects, in particular, cars https://olegkutkov.me/2023/11/07/connecting-external-gps-antenna-to-the-starlink-terminal/?fbclid=IwZXh0bgNhZW0CMTAAAR3ZqBXlaPcm37FZAVt7glQceJEDUFgRmDKq8KOFM-7u_EBmLdDzwYQtJV8_aem_P9vooapTI4yE-rIZUWIYXg. This solution partially resolves the problem of the terminal operation when the GNSS signal is suppressed, however, it deteriorates communication if the GNSS signals are distorted, and it cannot be used in unmanned control when loss of the geolocation results in loss of the object.

### SUMMARY OF THE INVENTION

Embodiments of the invention provide a reliable operation of satellite communication terminals in case of a signal absence or distortion of a signal from the Global Navigation Satellite Systems not only in cases of stationary position of terminals, but also when they are used on movable objects, e.g., on manned or unmanned vehicles.

The posed task is solved by providing a spatial position data transmission system comprising a satellite communication terminal comprising a central processor, an antenna, an oscillator, and a GNSS receiver. According to the invention, the system comprises a parameter optimization device comprising an additional high-accuracy oscillator, a microcontroller, and a source of spatial position data being external relative to the terminal, wherein the microcontroller is configured to turn on/off the oscillator and the GNSS receiver of the communication terminal and to connect the additional high-accuracy oscillator and the spatial position data source that is external relative to the terminal to the central processor of the terminal.

According to a possible exemplary embodiment of the invention, the spatial position data source that is external relative to the terminal is an additional secured GNSS receiver.

According to another exemplary embodiment of the invention, the spatial position data source being external relative to the terminal is a ground control unit of the movable object, and the satellite communication terminal is mounted on the ground control unit. The satellite communication terminal is configured to transmit its position data to an on-board computer thereof.

Due to addition of the additional high-accuracy oscillator to the satellite communication terminal and due to replacement of a nominal oscillator therewith, it becomes possible to maintain similar reading accuracy during current usage scenarios of the system. Therewith, if the oscillator and the GNSS receiver are turned off, a state will be provoked where the Global Navigation Satellite Systems are not registered, and the data about the current geolocation is received by the central processor via the microcontroller from the spatial position data source being external relative to the terminal, e.g., the secured GNSS receiver, or from the ground control unit of Earth surface surveillance data. This data is converted into a format that is identical to a format used by the nominal GNSS receiver of the terminal, and this data is transmitted to the central processor of the terminal instead of the data of its nominal GNSS receiver.

This configuration of the system allows to ensure unbroken communication, while receiving coordinates of the terminal without use of satellite navigation readings, reduces a risk of influence of signal replacement or suppression tools thereto, is interference-free and allows to maintain the accurate schedule and stably high communication level both during operation in stationary conditions and during movement, while ensuring coordination between time and physical location being sufficient for current usage scenarios.

### BRIEF DESCRIPTION OF THE DRAWINGS

In order to provide a more comprehensive understanding of the claimed invention and advantages thereof, the following description explains possible exemplary embodiments thereof with a reference to FIG. 1 of the appended drawing illustrating the following:
1. satellite communication terminal
2. central processor
3. GNSS receiver
4. antenna of the GNSS receiver
5. embedded oscillator of the terminal
6. optimization device
7. additional high-accuracy oscillator
8. microcontroller
9. external GNSS receiver
10. other data sources

FIG. 1 illustrates a block diagram of the interference-free spatial position data transmission system.

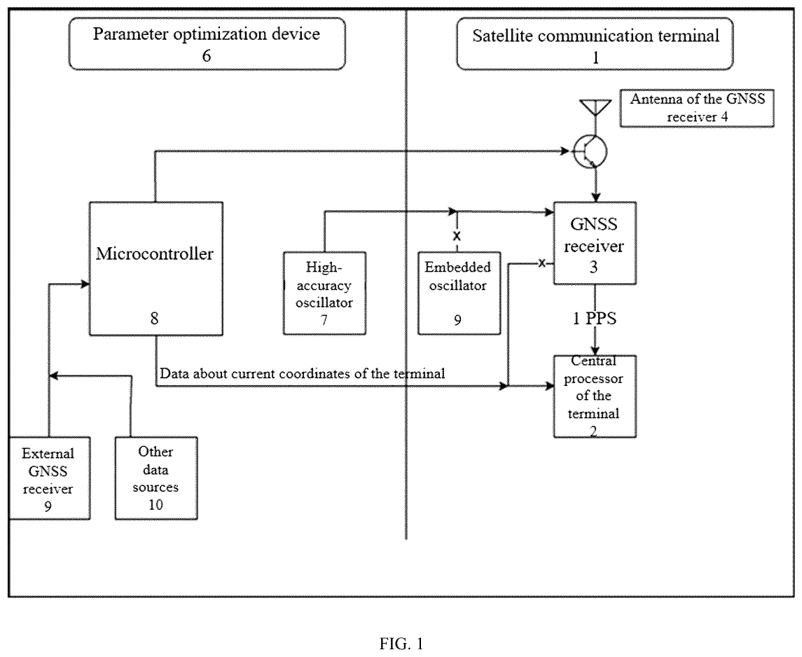

### Possibility of Implementation of the Invention

An interference-free system comprising a satellite communication terminal (1) that comprises a central processor (2), an oscillator and a GNSS receiver (3) with an antenna (4) and an embedded oscillator (5) of the terminal. The claimed system solves the problem of loss of data about accurate time due to addition, to the satellite communication terminal (1), an optimization device (6) for optimizing parameters of the system, the optimization device comprises an additional high-accuracy oscillator (7) having a minimum time shift, a microcontroller (8) having a software that ensures an operation logic and a spatial position data source being external relative to the terminal, the source may be an external GNSS receiver (9) or another data source (10). The device (6) is mounted on the terminal (1) such that it could replace nominal elements, and to this end, the microcontroller (8) is configured to turn on/off the oscillator (5) and the GNSS receiver (3) of the communication terminal (1) and to connect the additional high-accuracy oscillator (7) and the spatial position data source (9, 10) that is external relative to the terminal to the central processor (2) of the terminal (1).

When the device (6) is activated, the antenna (4) of the GNSS receiver (3) of the terminal (1) is turned off, thereby provoking a state GNSS NO FIX and forcing the terminal to trust the established high-accuracy oscillator (7). The time shift of the oscillator (7) mounted on the device (6) allows to maintain the required reading accuracy for almost 24 hours, and this is sufficient for all current usage scenarios. Therewith, the terminal (1) is able to maintain an accurate schedule and to potentially maintain a stable high level of communication under the proviso that it knows with which of the satellites from the group it must work. It is sufficient for operation of immovable terminals that interact with satellites on a geostationary Earth orbit, since the relative position of the terminal and the satellite must be determined once before start of operation, and then it will remain unchanged.

It will not be sufficient in case of most of modern satellite systems. Due to many factors, most of modern satellite groups consist of satellites located on a low (LEO, orbit height is ~160-1500 km, rotation period is ~90-120 minutes) or on a medium (MEO, orbit height is ~5000-20000 km, rotation period is ~2-12 hours) Earth orbit. That is, the relative position of the subscriber terminal and the satellites changes and the terminal is not physically able to maintain the communication channel with any single satellite continuously, since in the course of time it will be blocked by the planet's surface. In order to operate in nominal mode, the ground terminal must have data about three characteristics being a movement schedule of the satellites (this data is continuously transmitted by each of the satellites of the group), time, and current geolocation of the terminal.

In order to solve the first problem, the device (6) is supplemented with a communication interface with the external secured GNSS receiver (9), and according to this, one operation scenario of the system implies receipt of data about the current geolocation from the external secured GNSS receiver (9), conversion of this data into a format that is identical to a format used by the nominal GNSS receiver (3) of the terminal (1) and transmission of this data to central processor (2) of the terminal instead of the data of its nominal GNSS receiver (3). This operation scenario allows to obtain good results in most cases of ground usage of the terminal (1). In case of movable usage, in particular, air usage, i.e., when the all-directed antenna of the GNSS receiver (9) is located high up in the air and in no way is blocked by the suppression or distortion signals, even the secured GNSS receivers have restrictions and often stop to provide valid data about the position. To this end, a second usage scenario is provided in the system, where the data about the current geolocation is received by the microcontroller (8) of the device (6) from other external sources (10). In one of embodiments, visual navigation is used in case of UAVs. In this scenario, an operator receives an image from a camera of the UAV and, using the same, visually determines an approximate geolocation of the vehicle which is then, via an available communication channel, transmitted to the device (6) that, in turn, transmits it to the central processor (2) of the terminal (1) of the system.

The claimed system reduces a risk of influence of signal suppression or distortion tools thereto, is interference-free, and allows to maintain an accurate schedule and stable high communication level both during operation in stationary conditions and during movement, while ensuring coordination between time and geolocation being sufficient for current usage scenarios.

1. A spatial location data transmission system comprising a satellite communication terminal that comprises a central processor, an antenna, an oscillator and a Global Navigation Satellite Systems (GNSS) receiver, wherein the system comprises a parameter optimization device comprising an additional high-accuracy oscillator, a microcontroller and a source of spatial position data that is external relative to the terminal, and the microcontroller is configured to turn on/off the oscillator and the GNSS receiver of the communication terminal and to connect the additional high-accuracy oscillator and the spatial position data source that is external relative to the terminal to the central processor of the terminal.

2. The system according to claim 1, wherein the spatial position data source that is external relative to the terminal is an additional secured GNSS receiver.

3. The system according to claim 1, wherein the spatial position data source that is external relative to the terminal is a ground control unit of the movable object, and the satellite communication terminal is mounted on the ground control unit, the satellite communication terminal is configured to transmit its position data to an on-board computer thereof.
